(19) United States
(12) Patent Application Publication
(10) Pub. No.: US 2026/0349318 A1
(43) Pub. Date: Nov. 5, 2026

(54) PHOTOGRAPHIC EXPANSION ACCESSORY AND PHOTOGRAPHIC AUXILIARY APPARATUS

(71) Applicant: SHENZHEN LEQI INNOVATION CO., LTD., SHENZHEN, GUANGDONG (CN)

(72) Inventor: FENG ZHOU, SHENZHEN, GUANGDONG (CN)

(21) Appl. No.: 19/538,867

(22) Filed: Feb. 12, 2026

Related U.S. Application Data
(63) Continuation-in-part of application No. 18/512,051, filed on Nov. 17, 2023, now Pat. No. 12,585,175.
Application No. 18/512,051 is a continuation of application No. PCT/CN2022/115174, filed on Aug. 26, 2022.

(30) Foreign Application Priority Data
Sep. 6, 2021 (CN) 202122142473.3

(51) Int. Cl. G03B 17/56

(52) U.S. Cl. CPC G03B 17/561

(57) ABSTRACT

The present disclosure discloses a photographic expansion accessory and a photographic auxiliary apparatus. The photographic expansion accessory includes a camera base plate, which includes a plate body and a wrench. The plate body is defined with a battery avoiding port extending along a thickness direction of the plate body. The wrench is rotatably connected to the plate body, and the wrench defines a part of a side wall of the battery avoiding port.

### TECHNICAL FIELD

The present disclosure relates to the technical field of photographic device, and in particular to a photographic expansion accessory and a photographic auxiliary apparatus.

### BACKGROUND

In order to achieve good shooting effect, more and more photography enthusiasts use cameras or monitors combined with camera accessories, such as camera base plate, shoulder mount, quick release plate, and adapter bracket. The camera is provided with a battery compartment which defines an opening, and the opening is covered by a plate. Due to the limited capacity of the camera battery, it often needs to replace the camera battery during the shooting process. However, it is inconvenient to remove the camera from the camera base plate, so there is a need of the camera accessory (such as the camera base plate or camera protective frame), that is allowable for the replacement of the camera battery without removing the camera from the camera accessory.

### SUMMARY

The main purpose of the present disclosure is to provide a photographic expansion accessory, aiming to achieve removing a battery from a battery compartment of a camera without removing the camera from the camera base plate.

In order to achieve the above purpose, the present disclosure provides a photographic expansion accessory, including a camera base plate. The camera base plate includes a plate body and a wrench. The plate body is defined with a battery avoiding port corresponding to an opening of a battery compartment of a camera. The battery avoiding port extends along a thickness direction of the plate body. The wrench is rotatably connected to the plate body through a damping assembly, and the wrench defines a part of a side wall of the battery avoiding port.

In some embodiments, the photographic expansion accessory further includes a damping assembly disposed between the plate body and the wrench. The wrench is rotatably connected to the plate body via the damping assembly.

In some embodiments, the damping assembly includes a shaft. The shaft includes an end connected to the plate body and the other end rotatably connected to the wrench.

In some embodiments, the damping assembly further includes at least one first washer. The at least one first washer is disposed between the wrench and the plate body; and/or, the at least one first washer is disposed on a side of the wrench facing away from the plate body.

In some embodiments, the damping assembly includes a second connecting member, a shaft, and at least one first washer. The second connecting member is mounted to the plate body. The shaft includes an end connected to the second connecting member and the other end rotatably connected to the wrench. The at least one first washer is fitted on the shaft and located between the wrench and the second connecting member.

In some embodiments, the damping assembly includes a shaft, a first connecting member, a second connecting member, and at least one first washer. The first connecting member, the second connecting member, and the first washer are all located between two ends of the shaft. The first connecting member is rotatably sleeved on the shaft, and the second connecting member and the first washer are sleeved on the shaft. The at least one first washer is located between the first connecting member and the second connecting member. The first connecting member is fixedly connected to the wrench, and the second connecting member is fixedly connected to the plate body.

In some embodiments, the damping assembly further includes at least one elastic member sleeved on the shaft, and the elastic member is located on a side of the first connecting member away from the second connecting member, or on a side of the second connecting member away from the first connecting member.

In some embodiments, the elastic member is a spring or a bowl-shaped washer.

In some embodiments, the damping assembly further includes a second washer, and the second washer includes a first surface abutted the elastic member and a second surface abutted a side of the first connecting member. The second surface is provided with at least one limiting protrusion and the first connecting member is correspondingly defined with at least one slot. Or, the second surface is defined with at least one slot and the first connecting member is correspondingly provided with at least one limiting protrusion. Each limiting protrusion is capable of sliding into or out of a respective slot. Or, the second surface of the second washer abuts a side of the second connecting member. The second surface is provided with at least one limiting protrusion and the second connecting member is correspondingly defined with at least one slot. Or, the second surface is defined with at least one slot and the second connecting member is correspondingly provided with at least one limiting protrusion.

In some embodiments, at least one side of the limiting protrusion is provided with a first guiding slope, and at least one inner side wall of the slot is correspondingly provided with a second guiding slope. The first guiding slope abuts the second guiding slope.

In some embodiments, the limiting protrusion includes two opposite sides with each being provided with the first guiding slope. When the limiting protrusion is arranged on the second surface, a distance between the two first guiding slopes gradually decreases in a direction away from the second surface; when the limiting protrusion is arranged on the first connecting member or the second connecting member, the distance between the two first guiding slopes gradually increases in the direction away from the second surface. The slot includes two opposite sides with each being provided with the second guiding slopes, and a distance between the two second guiding slopes gradually increases in a direction away from a bottom wall of the slot.

In some embodiments, the wrench is defined with an accommodating groove to accommodate the first connecting member. And/or, a bottom wall of the accommodating groove is defined with a groove to accommodate an end of the shaft, the elastic member, and the second washer.

In some embodiments, both the second connecting member and the first washer are defined with a waist-shaped hole respectively. The shaft includes two opposite outer side walls with each defining an inclined surface, and the shaft passes through the waist-shaped holes of the second connecting member and the first washer.

In some embodiments, the camera base plate further includes a side plate and/or a top plate. And/or, the camera base plate further includes a locking member for connecting with the camera. And/or, a bottom surface of an end of the plate body away from the battery avoiding port is defined with a cold shoe groove. And/or, two sides of the plate body are provided with a slider respectively. And/or, the plate body is defined with a plurality of threaded holes.

In some embodiments, the plate body includes an upper surface and a lower surface opposite to the upper surface in the thickness direction of the plate body, the upper surface is configured to support a camera, and the lower surface is configured to connect to a support stand. The lower surface is defined with a receiving cavity configured to receive at least a part of the wrench, the receiving cavity is communicated with the battery avoiding port; a rotating shaft is provided on a bottom wall of the receiving cavity, and the rotating shaft extends in a direction away from the upper surface; and a torsion spring and the wrench are sequentially fitted on the rotating shaft, the wrench is rotatably arranged within the receiving cavity through the rotating shaft, and the torsion spring is configured to reset the wrench to a preset position.

The present disclosure further provides a photographic expansion accessory, including a plate body and a wrench. The plate body includes an upper surface and a lower surface opposite to the upper surface, the upper surface is configured to support a camera, and the lower surface is configured to connect to a support stand. The plate body is defined with a battery avoiding port penetrating through the upper surface and the lower surface, and the battery avoiding port is arranged to correspond to an opening of a battery compartment of the camera; and the wrench is detachably connected to the plate body, and the wrench defines a part of a sidewall of the battery avoiding port.

In some embodiments, the lower surface of the plate body is defined with a receiving cavity for receiving at least a part of the wrench, and the receiving cavity is communicated with the battery avoiding port; and a first magnetic member is provided on an inner wall of the receiving cavity, a second magnetic member is provided on the wrench, and the wrench is detachably mounted to the plate body through the first magnetic member and the second magnetic member.

In some embodiments, the lower surface of the plate body is defined with a receiving cavity for receiving at least a part of the wrench, and the receiving cavity is communicated with the battery avoiding port; and a snap-fit member is provided on a bottom wall of the receiving cavity, a second slot mating with the snap-fit member is defined in a surface of the wrench facing the receiving cavity, and the wrench is detachably mounted to the plate body by way of the snap-fit member clamping in the second slot.

The present disclosure further provides a photographic expansion accessory, including: a camera base plate, the camera base plate including a plate body and a wrench, the plate body being defined with a battery avoiding port penetrating through the plate body, the wrench being rotatably connected to the plate body through a damping assembly, and the wrench defining a part of a sidewall of the battery avoiding port; and a first frame, the first frame comprising an end connected to an end of the plate body and an extension end extending away from the plate body.

In some embodiments, photographic expansion accessory further includes a second frame. The second frame includes an end connected to the sidewall of the battery avoiding port and an extension end extending away from the plate body.

In some embodiments, photographic expansion accessory further includes a third frame. The third frame includes an end connected to the extension end of the first frame and the other end connected to the extension end of the second frame.

The present disclosure further provides a photographic auxiliary apparatus, including a support stand and a photographic expansion accessory mounted at an end of the support stand. The photographic expansion accessory is the photographic expansion accessory described in any one of the foregoing embodiments.

In the present disclosure, the wrench of the camera base plate is rotatably connected to the plate body through the damping assembly. The wrench defines a part of the side wall of the battery avoiding port, or the wrench can be gradually opened during the wrench rotating so as to define a gap in the battery avoiding port. After the plate at the opening of the camera’s battery compartment is fully opened, a portion of the plate extends into the gap, thereby the plate can be opened completely, such that the battery can be removed or placed in the camera without detaching the camera from the camera base plate, which is operating conveniently.

### BRIEF DESCRIPTION OF THE DRAWINGS

FIG. 1 is a perspective view of a camera base plate according to an embodiment of the present disclosure.

FIG. 2 is a perspective view of the camera base plate mounted with a camera according to an embodiment of the present disclosure.

FIG. 3 is an exploded view of the camera base plate according to an embodiment of the present disclosure.

FIG. 4 is an exploded view of a damping assembly of the camera base plate according to an embodiment of the present disclosure.

FIG. 5 is an exploded view of a wrench and the damping assembly of the camera base plate according to an embodiment of the present disclosure.

FIG. 6 is an exploded view of the wrench of the camera base plate according to an embodiment of the present disclosure.

FIG. 7 is a perspective view of a camera base plate according to another embodiment of the present disclosure.

FIG. 8 is a perspective view of a camera base plate according to still another embodiment of the present disclosure.

FIG. 9 is a structural schematic diagram of a wrench according to an embodiment of the present disclosure.

FIG. 10 is a structural schematic diagram of a photographic expansion accessory according to an embodiment of the present disclosure.

FIG. 11 is a structural schematic diagram of a photographic expansion accessory according to another embodiment of the present disclosure.

FIG. 12 is a structural schematic diagram of a photographic auxiliary apparatus according to an embodiment of the present disclosure.

### DETAILED DESCRIPTION OF THE EMBODIMENTS

Detailed descriptions of the embodiments of the present disclosure are provided below, with examples of the embodiments shown in the accompanying drawings. Throughout the description, the same or similar reference numerals indicate the same or similar elements or elements having the same or similar functions. The embodiments below, as illustrated in the drawings, are exemplary and are intended to illustrate the present disclosure, but should not be construed as limiting the scope of the present application. Based on the embodiments of the present disclosure, all other embodiments that can be obtained by those skilled in the art without exercising creative labor are within the scope of protection of the present disclosure.

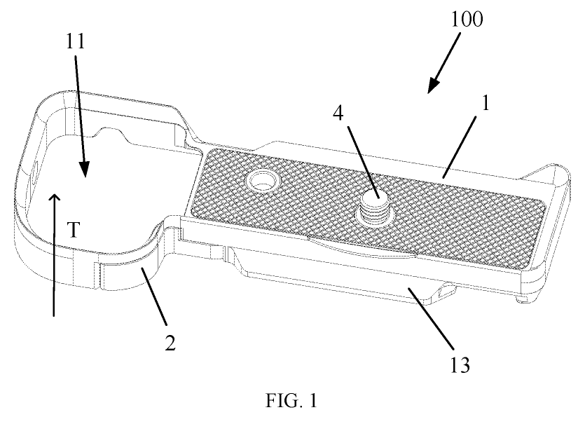

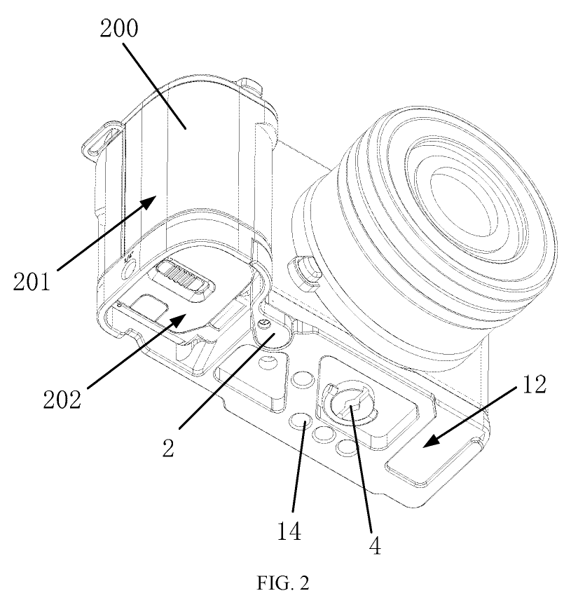

Referring to FIGS. 1-3, a camera 200 is typically provided with a battery compartment with an opening. An openable cover is provided at the opening. The cover is typically connected to a main body of the camera 200 via a snap-fit mechanism or a locking mechanism. Due to the limited capacity of the built-in battery of the camera 200, users usually need to replace the battery for prolonging shooting or supporting intensive use. When the camera 200 is mounted on a photographic expansion accessory such as a base plate, a protective frame, or a quick-release plate, due to a tight fit between the camera and the photographic expansion accessory, the opening of the battery compartment is commonly obstructed or restricted by the photographic expansion accessory . In such cases, replacing the battery requires detaching the camera from the accessory, replacing the battery, and then remounting the camera. This procedure is inefficient and particularly inconvenient in outdoor or time-sensitive shooting situations. The issue is further exacerbated when the accessory is screw-mounted to the camera, because repeated disassembly and reassembly are not only tedious and time-consuming but may also lead to thread wear or equipment damage if performed carelessly. To address the above issues, the present disclosure provides a photographic expansion accessory including a camera base plate 100. The camera base plate 100 includes a plate body 1 and a wrench 2. The plate body 1 is defined with a battery avoiding port 11 penetrating through the plate body 1. The wrench 2 is rotatably connected to the plate body 1, and the wrench 2 defines a part of a sidewall of the battery avoiding port 11. In this configuration, when the camera 200 is mounted on the camera base plate 100, user does not need to detach the camera 200 to replace battery. Instead, by way of simply rotating the wrench 2, the restriction on the cover of the battery compartment 201 is released, such that the cover can be fully opened. This facilitates removal and installation of the battery, thereby improving user experience and operational efficiency.

The present disclosure provides a photographic expansion accessory. As shown in FIGS. 1-3, the photographic expansion accessory includes a camera base plate 100, which includes a plate body 1 and a wrench 2. The plate body 1 is defined with a battery avoiding port 11 penetrating through the plate body 1 and extending in a thickness direction T of the plate body 1. The wrench 2 is rotatably connected to the plate body 1, and the wrench 2 serves as a part of a sidewall of the battery avoiding port 11.

The plate body 1 serves as the main body structure of the camera base plate, and is configured to carry the camera 200 and connect with the bottom of the camera 200. In some embodiments, the plate body 1 is made of a material such as aluminum alloy, magnesium alloy, engineering plastic, or carbon fiber composite, balancing structural strength and lightweight requirements. The plate body 1 is configured in a rectangular shape, a L-shape, or any other shape adapted to the contour of the camera 200 according to actual requirements. In some embodiments, the plate body 1 is defined with a threaded hole for connecting the camera 200. In some embodiments, the threaded hole is 1/4-inch standard threaded hole which adapts with the standard threaded interface at the bottom of the camera 200. In some embodiments, the plate body 1 is provided with a quick-release interface, a tripod connection hole, or other functional structures on its side surface or bottom surface, to support extended requirements in various shooting scenarios.

The plate body 1 is defined with the battery avoiding port 11 penetrating through the plate body 1 and extending in the thickness direction T of the plate body 1. The battery avoiding port 11 is located corresponding to an opening 202 of a battery compartment 201 of the camera 200. The battery avoiding port 11 is configured to provide clearance space for opening the cover of the battery compartment 201 after the camera 200 is assembled with the base plate 100. The battery avoiding port 11 may be rectangular, rounded rectangular, or another shape adapted to the movement of the cover. The size of the battery avoiding port 11 is slightly larger than the required operational space when the cover is fully opened, ensuring smooth opening or closing of the cover.

The wrench 2 is rotatably connected to the plate body 1 and serves as a part of the sidewall of the battery avoiding port 11. In some embodiments, the wrench 2 is located at a side edge of the battery avoiding port 11. In a default state, the wrench 2 acts as a part of the sidewall of the battery avoiding port 11, limiting and protecting the cover of the battery compartment 201. This effectively prevents the cover from being accidentally opened caused by unintended contact, thereby avoiding battery dislodgement during shooting. When battery replacement is required, users can rotate the wrench 2 away from the edge of the battery avoiding port 11, thereby defining a gap in the sidewall of the battery avoiding port 11 and providing sufficient space for the completely opening of the cover.

Various rotatable connection methods can be employed between the wrench 2 and the plate body 1 in according with practical requirements, which is not limited herein. In one embodiment , the wrench 2 is directly rotatably connected to the plate body 1 via a rotating shaft 16. For example, the rotating shaft 16 is a fastener such as a metal pin, a rivet, or a screw, which passes through corresponding shaft holes defined in the wrench 2 and the plate body 1, allowing the wrench 2 to rotate relative to the plate body 1. In another embodiment, an additional damping assembly 3 is provided to improve the operational feel during the rotation of the wrench 2, making its rotation smoother and more stable, while also allowing the wrench 2 to remain securely positioned at any rotational angle. There are multiple ways to provide the damping assembly 3. For example, basic damping elements such as washers, elastic elements, or friction plates are provided and arranged between the rotating shaft 16 and the shaft holes to achieve a damping effect by way of friction. For another example, a rotating shaft 16 integrated with damping function or a damping hinge is employed to achieve more stable and precise damping performance.

In yet another embodiment, a torsion spring 17 or a return spring is provided between the wrench 2 and the plate body 1. The torsion spring 17 includes an end connected to the wrench 2 and the other end connected to the plate body 1. In this configuration, after user rotates the wrench 2 to make the battery avoiding port 11 opened, once the wrench 2 is released, the torsion spring 17 provides a return torque to drive the wrench 2 to automatically return to an initial position of the wrench 2, thereby re-closing the battery avoiding port 11. This makes the operation more convenient.

In some other embodiments, the wrench 2 is detachably connected to the plate body 1. For example, the wrench 2 and the plate body 1 are connected via a magnetic attraction mechanism. The wrench 2 is provided with a magnetic member, and the plate body 1 is provided with another magnetic member which is attracted with the magnetic member provided on the wrench 2. In this configuration, user can directly remove the wrench 2 from the plate body 1 to open the battery avoiding port 11, and after replacing the battery, the wrench 2 is attracted to its initial position by magnetic attraction. Alternatively, the wrench 2 and the plate body 1 are connected via a snap-fit mechanism. The wrench 2 is provided with a snap-fit member 18, and the plate body 1 is defined with a corresponding slot mated with the snap-fit member 18. In this configuration, the wrench 2 can be detached by pressing or sliding the snap-fit member 18 to disengage the snap-fit connection.

In some embodiments, in addition to manual operation of the wrench 2, the wrench 2 can also be electrically driven. For example, a motor, such as a servo motor or a micro motor, is provided on the plate body 1, with the output shaft of the motor being connected to the wrench 2. Additionally, a control button or a touch-sensitive switch is provided at an appropriate position on the plate body 1, allowing the user to operate the button or the switch to control the rotation of the motor, thereby achieving automatic opening and closing of the wrench 2.

During shooting, the camera 200 is fixedly connected to the plate body 1 through threaded holes defined in the plate body 1, with the bottom of the camera 200 in close contact with the top surface of the plate body 1. The wrench 2 remains in its initial position, serving as a part of the sidewall of the battery avoiding port 11 to close one side of the battery avoiding port 11. The wrench 2 ensures the integrity of the sidewall of the battery avoiding port 11 and restrains the cover of the battery compartment 201 of the camera 200. Even if a snap-fit element of the cover is accidentally released caused by vibration or impact, the wrench 2 can prevent the cover from completely opening. This effectively avoids the risk of battery displacement during shooting, thereby ensuring operational continuity and safety.

When the user needs to replace the battery of the camera 200, locking mechanism (e.g., a slide-to-unlock button or a press-type snap-fit element) of the cover is first released, placing the cover in an openable state. Subsequently, the user operates the wrench 2, driving it to rotate relative to the plate body 1 and gradually move away from its initial position. As the wrench 2 rotates, the part of the sidewall of the battery avoiding port 11 gradually opens, creating a gap in the sidewall of the battery avoiding port 11.

When the wrench 2 is rotated to a predetermined angle (e.g., 90 degrees or another suitable angle), the gap becomes sufficiently large that is capable of receiving the fully opened cover. Then the cover can be fully opened and partially received in the gap, without no longer obstruction from the base plate. The user can then remove the battery from the battery compartment 201 and place a new one. After battery replacement is completed, the user closes and locks the cover. Subsequently, the user rotates the wrench 2 in the opposite direction to return it to its initial position, thereby reclosing the gap. In the configuration where a return member, such as the torsion spring 17, is disposed between the wrench 2 and the plate body 1, the user only needs to release the wrench 2, and the wrench 2 will automatically return to its initial position under the action of the return member, making the operation more convenient.

In the embodiments where the wrench 2 is electrically driven, the user does not need to manually rotate the wrench 2. Simply pressing the control button provided on the plate body 1 can activate the motor to drive the wrench 2 to automatically rotate to the open position. After battery replacement is completed, pressing the same button again or pressing another button can activate the motor to drive the wrench 2 to automatically return to its initial position. This is particularly advantageous when the camera 200 is mounted on a stabilizer, a gimbal, or other apparatus where manual operation of the wrench 2 is inconvenient.

According to the embodiments, the battery avoiding port 11 is defined in the plate body 1 to accommodate the cover of the battery compartment 201 of the camera 200. The wrench 2 is rotatably connected to the plate body 1 and forms a part of the sidewall of the battery avoiding port 11. Thus, when the wrench 2 is rotated, it progressively opens to form a gap in the sidewall of the battery avoiding port 11. After the cover is fully opened, the cover is partially received in the gap. . This effectively prevents any failure in battery replacement caused by failure in completely opening the cover and eliminates the need to detach the camera 200 from the base plate for battery replacement.

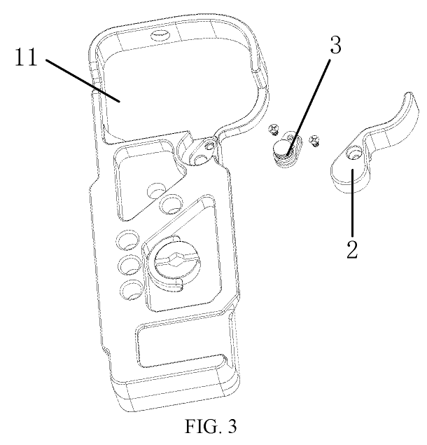

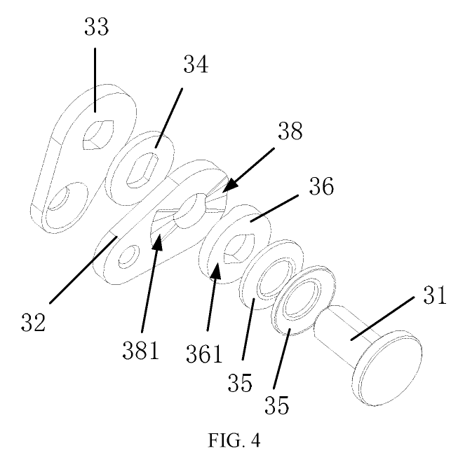

In some embodiments, with reference to FIGS. 3 and 4, the photographic expansion accessory further includes a damping assembly 3 arranged between the plate body 1 and the wrench 2. The wrench 2 is rotatably connected to the plate body 1 via the damping assembly 3.

In the embodiments, the wrench 2 and the plate body 1 are rotatably connected by employing the damping assembly 3. The damping assembly 3 is configured to provide an appropriate damping force for the rotation of the wrench 2. This damping force gives users a sense of resistance during rotation of the wrench 2, thereby improving the operational feel. Also, it allows the wrench 2 to remain stable at any rotational angle, preventing unintended rotation or wobbling caused by its own weight or external vibrations.

In some embodiments, the damping assembly 3 is a mechanical damping assembly. For example, the damping assembly 3 includes a rotating shaft 16 and structural members such as washers, elastic washers, or friction plates fitted on the rotating shaft 16. The structural members are sequentially stacked and compressed at the connection point between the wrench 2 and the plate body 1, introducing frictional resistance that need to be overcome during rotating the wrench 2. This friction generates a damping effect, which in turn provides buffering and positioning functionality. Alternatively, the damping assembly 3 is configured as a damping rotating shaft 16 or a damping hinge, which integrates with elements such as damping grease, damping gears, or damping springs, to provide more stable and uniform damping torque.

In some embodiments, the damping assembly 3 is an electromagnetic damping assemblys. For example, the damping assembly 3 includes an electromagnet provided on the plate body 1, and a magnetic-conductive member or a permanent magnet provided on the wrench 2. The interaction between the magnetic field generated by the energized electromagnet and the magnetic-conductive member or the interaction between the magnetic field generated by the energized electromagnet and the permanent magnet creates an electromagnetic damping force on the rotation of the wrench 2. For another example, the damping assembly 3 operates on the principle of eddy current damping, where a conductive metal member is provided on either the wrench 2 or the plate body 1. When the wrench 2 rotates, the conductive metal member cuts through the magnetic lines of force, inducing eddy currents. The interaction between the eddy currents and the magnetic field generates a motion-resisting damping force. By employing the electromagnetic damping assembly 3, the damping force can be controlled by adjusting the current intensity. Additionally, this involves no mechanical wear, resulting in a long service life.

In the embodiments, the damping assembly 3 ensures smoother and more stable rotation of the wrench 2, providing a comfortable tactile feel. Additionally, the wrench 2 can remain securely positioned at any position during its opening or closing processing without requiring an additional locking mechanism, thereby enhancing user experience.

In some embodiments, the damping assembly 3 includes a shaft 31. The shaft 31 includes an end connected to the plate body 1 and the other end rotatably connected to the wrench 2. In this configuration, the wrench 2 is rotatably connected to the plate body 1 via the shaft 31. The wrench 2 is defined with a counterbore, which is configured to allow a bolt to pass through and connect to the shaft 31. By adjusting the tightening force of the bolt relative to the shaft 31, the magnitude of the damping force between the wrench 2 and the plate body is regulated.

In some embodiments, the damping assembly 3 further includes at least one first washer 34. The at least one first washer 34 is arranged between the wrench 2 and the plate body 1; alternatively, the at least one first washer 34 is arranged on the side of the wrench 2 facing away from the plate body 1.

In the embodiments, in addition to the shaft 31, at least one first washer 34 is provided. In some embodiments, the first washer 34 is an annular washer fitted on the shaft 31. It should be noted that the first washer 34 can be disposed in various configurations. For example, at least one first washer 34 is disposed only between the wrench 2 and the plate body 1. For another example, at least one first washer 34 is disposed only on the side of the wrench 2 facing away from the plate body 1. For yet another example, first washers 34 are provided both between the wrench 2 and the plate body 1 and on the side of the wrench 2 facing away from the plate body 1. In the configuration where the first washer 34 is disposed on the side of the wrench 2 facing away from the plate body 1, the portion of the plate body 1 connected to the wrench 2 is defined with a U-shaped notch. The wrench 2 is rotatably mounted within the U-shaped notch via the shaft 31, allowing the first washer 34 to be positioned on the side of the wrench 2 facing away from the plate body 1. The first washer 34 enhances friction between the wrench 2 and the plate body 1 while minimizing direct contact wear between the wrench 2 and the plate body 1.

In some embodiments, the damping assembly 3 includes a shaft 31 and at least one first washer 34. One end of the shaft 31 is connected to the plate body 1, and the other end of the shaft 31 is rotatably connected to the wrench 2. The at least one first washer 34 is fitted on the shaft 31 and located between the wrench 2 and the plate body 1.

In the embodiments, the shaft 31 serves as the rotational connection structure between the wrench 2 and the plate body 1, providing rotation axis for the wrench 2. One end of the shaft 31 is fixedly connected to the plate body 1 by means of threaded connection, riveting, welding, or interference fit. The other end of the shaft 31 passes through a shaft hole defined in the wrench 2, allowing the wrench 2 to rotate about the shaft 31. In some embodiments, the shaft 31 is made of a metal material (e.g., stainless steel, aluminum alloy) or high-strength engineering plastic to ensure sufficient structural strength and wear resistance.

The first washer 34 is fitted on the shaft 31 and located between the wrench 2 and the plate body 1. When the wrench 2 rotates relative to the plate body 1, a friction force is generated between the wrench 2 and the first washer 34, and between the first washer 34 and the plate body 1. This friction force constitutes the damping force provided by the damping assembly 3. The frictional force imparts a perceptible resistance to the rotation of the wrench 2, allowing the wrench 2 to remain securely in place at any angle without self-returning or wobbling caused by its own weight or minor external forces.

The number of first washers 34 can be selected based on the required magnitude of the damping force, ranging from one to multiple. In the configuration of multiple first washers 34, friction is generated between the multiple first washers 34, further enhancing the damping effect. The first washer 34 can be made from various materials, including but not limited to, metal, nylon, polytetrafluoroethylene, rubber, or felt. Washers made of different materials exhibit different coefficients of friction and wear resistance, which can be selected based on the required damping feel and service life in practical applications.

In some embodiments, the damping assembly 3 includes a second connecting member 33, a shaft 31, and at least one first washer 34. The second connecting member 33 is installed on the plate body 1. The shaft 31 includes an end fixedly connected to the second connecting member 33 and the other end rotatably connected to the wrench 2. The at least one first washer 34 is fitted on the shaft 31 and located between the wrench 2 and the second connecting member 33.

In the embodiments, an additional second connecting member 33 is provided, thereby converting the connection between the shaft 31 and the plate body 1 into a two-stage configuration: a fixed connection between the shaft 31 and the second connecting member 33, and an installation connection between the second connecting member 33 and the plate body 1.

The second connecting member 33 is installed on the plate body 1 and fixedly connected to the plate body 1 by means of a screw, a rivet, a snap-fit component, or embedding, ensuring a relative stationary between the second connecting member 33 and the plate body 1. One end of the shaft 31 is fixedly connected to the second connecting member 33 by means such as threaded engagement, welding, press-fitting, or integral molding, thereby ensuring a relative stationary between the shaft 31 and the second connecting member 33. The other end of the shaft 31 passes through the shaft hole defined in the wrench 2, allowing the wrench 2 to rotate about the shaft 31. The first washer 34 is fitted on the shaft 31 and located between the wrench 2 and the second connecting member 33. When the wrench 2 rotates relative to the plate body 1, the second connecting member 33 remains stationary relative to the plate body 1, and the shaft 31 remains stationary relative to the second connecting member 33. Consequently, rotation of the wrench 2 about the shaft 31 generates frictional force between the first washer 34 and the second connecting member 33, thereby producing the damping effect (it should be noted that in the embodiments, the first washer 34 is fixedly connected to the wrench 2 and does not rotate relative to the wrench 2).

In the embodiments, the second connecting member 33 can be made from a material different from that of the plate body 1, or the second connecting member 33 is subjected to a special surface treatment, allowing the surface friction coefficient of the side of the second connecting member 33 facing the first washer 34 is greater than that of the surface of the plate body 1 itself. For example, the second connecting member 33 is made from a material with a high friction coefficient, such as rubber, silicone, or metal with a rough surface texture. Alternatively, the surface of the second connecting member 33 undergoes roughening treatments like knurling, sandblasting, or brushing, to increase surface roughness. This configuration enhances the frictional force between the first washer 34 and the second connecting member 33 compared to the alternative configuration where the first washer 34 is in direct contact with the plate body 1, thereby achieving stronger damping performance under a same pressing force. This results in a more stable and controllable tactile feel when rotating the wrench 2.

In some embodiments, referring to FIGS. 1-3, the camera base plate 100 includes a plate body 1 and a wrench 2. The plate body 1 is defined with a battery avoiding port 11 corresponding to an opening 202 of a battery compartment 201 of a camera 200. The battery avoiding port 11 extends along a thickness direction of the plate body 1. The wrench 2 is rotatably connected to the plate body 1 through a damping assembly 3, and the wrench 2 defines a part of a side wall of the battery avoiding port 11.

In the present disclosure, the wrench 2 of the camera base plate 100 is rotatably connected to the plate body 1 through the damping assembly 3. The wrench 2 defines a part of the side wall of the battery avoiding port 11, or the wrench 2 can be gradually opened during the wrench 2 rotating so as to define a gap in the battery avoiding port 11. After a plate at the opening 202 of the camera’s battery compartment 201 is fully opened, a portion of the plate extends into the gap, thereby the plate can be opened completely, such that the battery can be removed or placed in the camera 200 without detaching the camera 200 from the camera base plate 100, which is operating conveniently.

In this embodiment, the wrench 2 can be opened or closed smoothly by way of a damping effect of the damping assembly 3, which improves user experience. The camera base plate 100 covers a part of outer surface of the camera 200 to protect the camera 200. The camera base plate 100 is also configured to be connected with a photographic accessory to assist the camera 200 in shooting. The camera base plate 100 may be a square frame, an L-shaped plate, a C-shaped plate, or other shapes, which can partially or fully cover around the camera 200. The camera base plate 100 includes edges in the form of a plate or a strip. The camera base plate 100 may be made of metal material, and the camera base plate 100 may be an integration or an assembly. The battery avoiding port 11 matches the shape of the opening 202 of the battery compartment 201, and the wrench 2 supports the camera 200. The camera base plate 100 can be provided with two side plates and a top plate, or only a side plate. The battery avoiding port 11 is defined in the plate body 1 and can be set according to an orientation of the opening 202 of the battery compartment 201 of the camera 200. For example, the battery compartment 201 of the camera 200 is commonly arranged uprightly on a left side or a right side of the camera 200, the opening 202 is defined in a bottom of the battery compartment 201, and an outer wall of the battery compartment 201 can be held or gripped by users.

In some embodiments, referring to FIGS. 4-6, the damping assembly 3 includes a shaft 31, a first connecting member 32, a second connecting member 33, and at least one first washer 34. The first connecting member 32, the second connecting member 33, and the first washer 34 are all located between two ends of the shaft 31. The first connecting member 32 is rotatably sleeved on the shaft 31. The second connecting member 33 and the first washer 34 are sleeved on the shaft 31. The at least one first washer 34 is located between the first connecting member 32 and the second connecting member 33. The first connecting member 32 is fixedly connected to the wrench 2, and the second connecting member 33 is fixedly connected to the plate body 1.

The first connecting member 32, the second connecting member 33, and the first washer 34 are all located between the two ends of the shaft 31. One end of the shaft 31 is provided with a circular limiting portion, with the first connecting member 32, the first washer 34, and the second connecting member 33 sequentially abutting on a side of the limiting portion. The other end of the shaft 31 is connected with a nut, or the other end of the shaft 31 is enlarged to limit the first connecting member 32, the first washer 34, and the second connecting member 33. During assembly, the first connecting member 32, the first washer 34, and the second connecting member 33 are sequentially passed through the shaft 31 and abutted on the side of the limiting portion. Then, the other end of the shaft 31 is fitted with the nut, or is hammered or stamped for riveting. The first washer 34 can be a circular thin sheet, the first connecting member 32 can be fixed and connected to the wrench 2 through a screw, and the second connecting member 33 can be fixed and connected to the plate body 1 through another screw. The shaft 31 is exposed on an out side of the wrench 2, or one end of the shaft 31 is rotatably accommodated inside or at one end of the wrench 2. After assembly, in case the wrench 2 is rotated, the wrench 2 drives the first connecting member 32 to rotate around the shaft 31, while the shaft 31, the second connecting member 33, and the plate body 1 remain relatively stationary. This allows the wrench 2 to be opened to a preset position, then users can open the plate benefit by the battery avoiding port 11, so as to place the battery into the battery compartment 201 or remove the battery from the battery compartment 201. Then the plate is closed, and the wrench 2 returns to its original position. The preset position is defined as a position in which the wrench 2 opens to form the gap in the battery avoiding port 11 to allow the plate to be fully opened. An opening angle of the wrench 2 can be set according to the need of the size of the gap in the battery avoiding port 11. A head of the wrench 2 is accommodated in a limiting groove of the plate body 1, and in case the wrench 2 abuts a side wall of an opening of the limiting groove, the wrench 2 is prevented from continuing to rotate; in case the wrench 2 abuts another side wall of the opening of the limiting groove, the wrench 2 is prevented from continuing to rotate. Therefore, a range of the opening angle of the wrench 2 is cooperatively controlled by the two side walls of the limiting groove and two sides of the wrench 2.

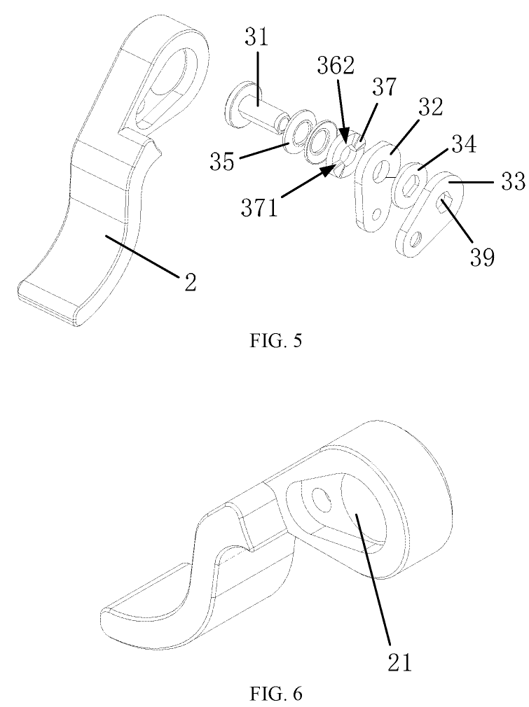

In some embodiments, referring to FIGS. 4 and 5, the damping assembly 3 further includes at least one elastic member 35 sleeved on the shaft 31. The elastic member 35 is located on a side of the first connecting member 32 away from the second connecting member 33, or on a side of the second connecting member 33 away from the first connecting member 32, allowing the first connecting member 32, the second connecting member 33, and the first washer 34 on the shaft 31 to provide a continuous bearing along an axial direction of the shaft 31. In order to facilitate the operation of the wrench 2 or improve users experience, the elastic member 35 is a spring or a bowl-shaped washer. The spring and the bowl-shaped washer may undergo deformation along the axial direction of the shaft 31 to accommodate compressing or releasing. The number of the elastic member 35 can be one, two, or more. The more the number of the elastic member 35, the smaller the compression force each elastic member 35 bears, and the longer the service life. A side of the bowl-shaped washer is defined with a curved groove, and another side is a curved shape. The spring may be a compression spring.

In some embodiments, referring to FIGS. 4 and 5, the damping assembly 3 further includes a second washer 36. The second washer 36 includes a first surface 361 abutted the elastic member 35 and a second surface 362 abutted a side of the first connecting member 32. The second surface 362 is provided with at least one limiting protrusion 37 and the first connecting member 32 is correspondingly defined with at least one first slot 38. Each limiting protrusion 37 is capable of sliding into or out of a respective first slot 38. Or, the second surface 362 is defined with at least one first slot 38 and the first connecting member 32 is correspondingly provided with at least one limiting protrusion 37.

The first connecting member 32 and the second washer 36 rotate in coordination with each other by means of the first slot 38 and the limiting protrusion 37. In case the wrench 2 is closed on the side wall of the battery avoiding port 11, the limiting protrusions 37 of the second washer 36 are correspondingly accommodated in the first slots 38 of the first connecting member 32. As the wrench 2 is gradually opened to form the gap in the battery avoiding port 11, the limiting protrusions 37 gradually slide out of the first slots 38 and slide along the second surface 362 of the first connecting member 32, causing compression of the elastic member 35, thereby ensuring smooth sliding of the limiting protrusions 37. As the wrench 2 retract, the limiting protrusions 37 slide back along an original path on the second surface 362 of the first connecting member 32. When the limiting protrusion 37 slides into the first slot 38, users may perceive, and the elastic member 35 is restored for preventing the wrench 2 from being easily opened. The number of the limiting protrusion 37 may be one, two, or more, and the limiting protrusions 37 may be arranged at equal intervals. A distance between adjacent limiting protrusion 37 can be equal. The limiting protrusion 37 can be trapezoidal, circular, and etc.

In some embodiments, the second surface 362 of the second washer 36 abuts a side of the second connecting member 33. The second surface 362 is provided with at least one limiting protrusion 37 and the second connecting member 33 is correspondingly defined with at least one first slot 38. Or, the second surface 362 is defined with at least one first slot 38 and the second connecting member 33 is correspondingly provided with at least one limiting protrusion 37.

In some embodiments, referring to FIGS. 4 and 5, at least one side of the limiting protrusion 37 is provided with a first guiding slope 371, and at least one inner side wall of the first slot 38 is correspondingly provided with a second guiding slope 381. The first guiding slope 371 abuts the second guiding slope 381.

As the wrench 2 is gradually opened to from the gap in the battery avoiding port 11, the limiting protrusions 37 gradually slide out of the first slots 38 along the second guiding slope 381 of the first slots 38, without getting stuck or experiencing any roughness. The limiting protrusions 37 then continue to slide along the second surface 362 of the first connecting member 32, causing the elastic member 35 to deform and shorten due to compression, ensuring smooth sliding of the limiting protrusions 37. As the wrench 2 retract, the limiting protrusions 37 slide back along the original path on the second surface 362 of the first connecting member 32. When the limiting protrusion 37 slides into the first slot 38, the second guiding slope 381 of the first slot 38 gradually guides the limiting protrusion 37 into the first slot 38, providing the limiting protrusion 37 an instant acceleration of the sliding speed, allowing the limiting protrusion 37 to quickly slide into the first slot 38, which provides users a perceiving and prevents the wrench 2 from being easily opened. The limiting protrusion 37 is provided with two first guiding slopes 371 matching the shape of the first slot 38, to limit the movement of the wrench 2 and thus prevents the wrench 2 from shaking.

In some embodiments, referring to FIGS. 4 and 5, the limiting protrusion 37 includes two opposite sides with each being provided with the first guiding slope 371. In case the limiting protrusion 37 is arranged on the second surface 362, a distance between the two first guiding slopes 371 gradually decreases in a direction away from the second surface 362; in case the limiting protrusion 37 is arranged on the first connecting member 32 or the second connecting member 33, the distance between the two first guiding slopes 371 gradually increases in the direction away from the second surface 362. The first slot 38 includes two opposite sides with each being provided with the second guiding slopes 381, and a distance between the two second guiding slopes 381 gradually increases in a direction away from a bottom wall of the first slot 38. In some embodiments, a top surface between the two first guiding slopes 371 of the limiting protrusion 37 can be V-shaped, and a bottom surface between the two second guiding slopes 381 of the first slot 38 can be V-shaped.

In some embodiments, referring to FIGS. 4-6, the elastic member 35 and the second washer 36 are located on one side of the first connecting member 32. The wrench 2 is defined with an accommodating groove 21 to accommodate the first connecting member 32. A bottom wall of the accommodating groove 21 is defined with a groove to accommodate an end of the shaft 31, the elastic member 35, and the second washer 36.

The end of the shaft 31 with the limiting portion can be rotatably accommodated in the accommodating groove 21, and the second washer 36 and the elastic member 35 that are located on one side of the first connecting member 32 are both accommodated in the accommodating groove 21, making the overall appearance of the camera base plate 100 neat and the structure compact.

In some embodiments, the elastic member 35 and the second washer 36 are located on one side of the second connecting member 33. The wrench 2 is defined with the accommodating groove 21 to accommodate the first connecting member 32. The plate body 1 is defined with a groove to accommodate the end of the shaft 31, the elastic member 35, and the second washer 36.

In some embodiments, referring to FIGS. 4 and 5, both the second connecting member 33 and the first washer 34 are defined with a waist-shaped hole 39 respectively. The shaft 31 includes two opposite outer side walls with each defining an inclined surface, and the shaft 31 passes through the waist-shaped holes 39 of the second connecting member 33 and the first washer 34.

In order to prevent the second connecting member 33 and the first washer 34 from rotating relative to the shaft 31, the second connecting member 33 and the first washer 34 can be locked onto the shaft 31 by way of the waist-shaped hole 39. A cross-section of the shaft 31 is a waist shape. After the second connecting member 33 being sleeved on the shaft 31, the inclined surface of the outer side walls of the shaft 31 abuts an inner wall of the waist-shaped hole 39.

In some embodiments, the camera base plate 100 further includes a locking member 4 for connecting with the camera 200. The locking member 4 can be a screw. A bottom surface of an end of the plate body 1 away from the battery avoiding port 11 is defined with a cold shoe groove 12. The cold shoe groove 12 is configured for installing a camera light or microphone. Two sides of the plate body 1 are provided with a slider 13 respectively. The slider 13 can be a dovetail slider, which is configured to be connected with a dovetail groove. The plate body 1 is defined with a plurality of threaded holes 14, which are configured to be connected with other accessories.

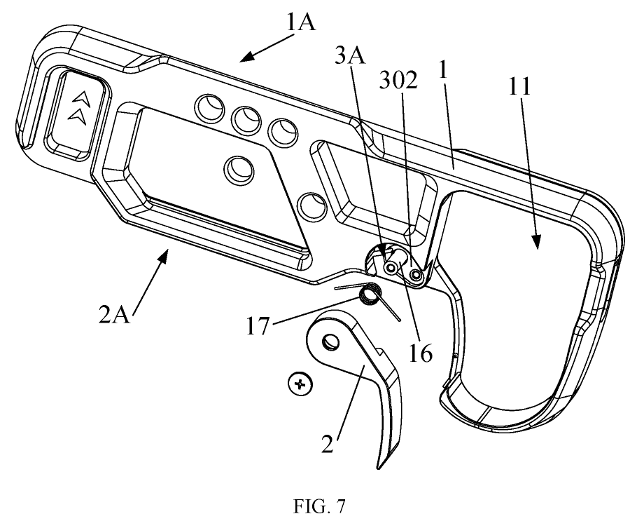

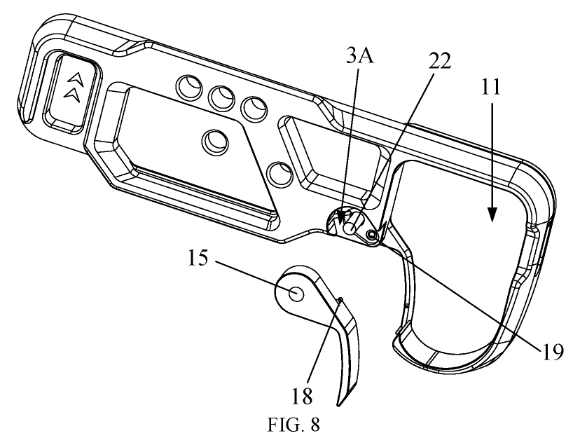

In an embodiment, referring to FIG. 7, the plate body 1 has an upper surface 1A and a lower surface 2A facing the upper surface 1A in the thickness direction T of the plate body 1. The upper surface 1A is configured to support a camera, and the lower surface 2A is configured to connect to a support stand 301. The lower surface 2A is provided with a receiving cavity 3A for receiving at least a part of the wrench 2. The receiving cavity 3A is communicated with the battery avoiding port 11, and a rotating shaft 16 is provided on a bottom wall of the receiving cavity 3A. The rotating shaft 16 extends in a direction away from the upper surface 1A. A torsion spring 17 and the wrench 2 are sequentially fitted on the rotating shaft 16. The wrench 2 is rotatably disposed within the receiving cavity 3A via the rotating shaft 16, and the torsion spring 17 is configured to return the wrench 2 to a preset position.

The embodiments provide another implementation for rotatable connection between the wrench 2 and the plate body 1, alternative to the foregoing embodiments where the wrench 2 is rotatably connected to the plate body 1 via the damping assembly 3. In the embodiments, the rotating shaft 16 cooperates with the torsion spring 17, allowing the wrench 2 to automatically reset after rotation.

The plate body 1 has the upper surface 1A and the lower surface 2A facing the upper surface 1A in the thickness direction T of the plate body 1. The upper surface 1A faces the camera 200 and is configured to support and contact the bottom of the camera 200. The lower surface 2A faces away from the camera 200 and is configured to connect to the support stand 301, such as a tripod, a gimbal, or a stabilizer.

The lower surface 2A of the plate body 1 is provided with the receiving cavity 3A. In some embodiments, the receiving cavity 3A is configured as a groove or cavity recessed from the lower surface 2A toward the upper surface 1A. The receiving cavity 3A is configured to receive at least a part of the wrench 2, thereby preventing the wrench 2 from protruding excessively beyond the lower surface 2A of the plate body 1 during rotation. This avoids interfering with the connection between the plate body 1 and the support stand 301 and provides protection for the wrench 2. The receiving cavity 3A is communicated with the battery avoiding port 11, allowing the gap to be defined in the sidewall of the battery avoiding port 11 for the cover of the battery compartment 201 to extend into when the wrench 2 is rotated open.

The rotating shaft 16 is disposed on the bottom wall of the receiving cavity 3A. The rotating shaft 16 extends from the bottom wall of the receiving cavity 3A in the direction away from the upper surface 1A. That is, the rotating shaft 16 protrudes downward from the bottom wall of the receiving cavity 3A. The rotating shaft 16 is integrally formed with the plate body 1, or the rotating shaft 16 is a separate structure fixed to the bottom wall of the receiving cavity 3A by means of threaded connection, press-fitting, welding, or the like. The torsion spring 17 and the wrench 2 are sequentially fitted on the rotating shaft 16. The torsion spring 17 includes a coil portion and two connecting ends extending outward from both ends of the coil portion. The coil portion is fitted on the rotating shaft 16. The two connecting ends of the torsion spring 17 are respectively configured for connecting to the receiving cavity 3A and the wrench 2. For example, one connecting end of the torsion spring 17 is fixedly connected to the inner wall of the receiving cavity 3A, which may be achieved by engaging the connecting end into a snap-fit groove defined in the inner wall of the receiving cavity 3A, hooking the connecting end onto a protrusion provided on the inner wall, or directly abutting the connecting end against the inner wall; the other connecting end of the torsion spring 17 is connected to the wrench 2, which may be achieved by engaging the other connecting end into a snap-fit groove defined in the wrench 2, hooking the other connecting end onto a protrusion provided on the wrench 2, or cooperating the other connecting end with a connection hole defined in the wrench 2. The wrench 2 is fitted on the rotating shaft 16 and located on the outer side of the torsion spring 17 (i.e., the side of the torsion spring 17 away from the bottom wall 302 of the receiving cavity 3A). The wrench 2 is defined with a shaft hole adapted to the rotating shaft 16, allowing the wrench 2 to rotate freely around the rotating shaft 16.

When the user needs to replace the battery, the wrench 2 is operated to rotate about the rotating shaft 16, which drives the corresponding connecting end of the torsion spring 17 to rotate, causing the coil portion of the torsion spring 17 to undergo elastic torsional deformation and store elastic potential energy. When the wrench 2 is rotated to the open position, a gap is defined in the sidewall of the battery avoiding port 11, allowing the user to complete the battery removal and insertion. After the battery is replaced, the user releases the wrench 2. The torsion spring 17 releases the stored elastic potential energy, generating a return torque that drives the wrench 2 to rotate in the reverse direction, allowing the wrench 2 to automatically return to its initial position and thereby reclosing the gap of the battery avoiding port 11. Thus, there is no need for the user to manually reset the wrench 2, making the operation more convenient and effortless.

In some embodiments, the photographic expansion accessory includes a plate body 1 and a wrench 2. The plate body 1 has the upper surface 1A and the lower surface 2A. The upper surface 1A is configured for mounting a camera, and the lower surface 2A is configured for connecting to a photographic accessory 301, such as a support stand 301. The plate body 1 is defined with a battery avoiding port 11 penetrating through the upper surface 1A and the lower surface 2A. The battery avoiding port 11 is arranged to locate corresponding with the opening 202 of the battery compartment 201 of the camera 200. The wrench 2 is detachably connected to the plate body 1, and the wrench 2 defines a part of the sidewall of the battery avoiding port 11.

The embodiments provide an alternative implementation in which the wrench 2 is detachably connected to the plate body 1 and defines a part of the sidewall of the battery avoiding port 11. This differs from the rotational connection between the wrench 2 and the plate body 1 described in the foregoing embodiments. In the embodiments, when battery replacement is required, the user can directly remove the wrench 2 from the plate body 1, allowing the sidewall of the battery avoiding port 11 to define a fully opened gap, providing ample clearance space for opening the cover. After the battery is replaced, the user reattaches the wrench 2 to the plate body 1, allowing the wrench 2 to again form a portion of the sidewall of the battery avoiding port 11 and restore its positioning and protective function for the cover.

The detachable connection between the wrench 2 and the plate body 1 can be implemented in various forms. For example, the detachable connection is a magnetic attraction connection, where corresponding magnetic members, such as a permanent magnet and a ferromagnetic metal plate, are respectively arranged on the wrench 2 and the plate body 1 to attract and hold with each other. The wrench 2 is fixed to the plate body 1 via a magnetic force, and can be easily detached by applying a certain pulling force, making the operation simple and quick. Alternatively, the detachable connection is a snap-fit connection, where a snap-fit member such as a snap-fit hook or a snap-fit block is provided on the wrench 2 and a corresponding second slot 19 or hole is defined in the plate body 1. The wrench 2 is fixedly connected to the plate body 1 through the engagement of the snap-fit member and the second slot 19, and the connection can be released by operating the snap-fit member. As another example, the detachable connection is a plug-in connection, where a pin or a plug is provided on the wrench 2 and a matching insertion hole is defined in the plate body 1. The connection is achieved by inserting the pin or the plug into the insertion hole, and detachment is accomplished by pulling the pin or the plug out.

The detachable connection in the embodiments offers advantages. The wrench 2 can be completely removed from the plate body 1, creating a larger gap in the sidewall of the battery avoiding port 11. This provides more ample operational space for opening the cover and accessing the battery, making it particularly suitable for the camera 200 with a wide-opening cover or a larger battery. Additionally, the removable wrench 2 facilitates individual cleaning, replacement, or storage. When the positioning and protective function of the wrench 2 is not required, user can also remove it to reduce overall weight.

In some embodiments, the lower surface 2A of the plate body 1 is defined with a receiving cavity 3A for accommodating at least a part of the wrench 2. The receiving cavity 3A is communicated with the battery avoiding port 11. A first magnetic member 22 is provided on the inner wall of the receiving cavity 3A, and a second magnetic member 15 is provided on the wrench 2. The wrench 2 is detachably mounted to the plate body 1 via the first magnetic member 22 and the second magnetic member 15.

The first magnetic member 22 is arranged on the inner wall of the receiving cavity 3A, and the second magnetic member 15 is arranged on the wrench 2 at a position corresponding to the first magnetic member 22. Both the first magnetic member 22 and the second magnetic member 15 are permanent magnets, with their opposing poles arranged to have opposite polarities, thereby generating an attractive magnetic force between them. Alternatively, one of the first magnetic member 22 and the second magnetic member 15 is a permanent magnet and the other of the first magnetic member 22 and the second magnetic member 15 is a ferromagnetic metal member, such as an iron, nickel, or cobalt plate, that is attracted by the magnetic force. In some embodiments, the first magnetic member 22 is installed on the inner wall of the receiving cavity 3A by means such as embedding, adhesive bonding, or screw fixation; and the second magnetic member 15 is installed on the wrench 2 by means such as embedding, adhesive bonding, or screw fixation.

When the wrench 2 is installed within the receiving cavity 3A, the first magnetic member 22 and the second magnetic member 15 attract and hold with each other, securely fixing the wrench 2 to the plate body 1 via the magnetic force. In this state, the wrench 2 forms a part of the sidewall of the battery avoiding port 11, providing positioning and protection for the battery compartment cover. When battery replacement is required, user only needs to apply a pulling force to overcome the magnetic force, allowing the wrench 2 to be easily removed from the receiving cavity 3A. This operation is simple, requiring no additional actions such as pressing a snap-fit mechanism or rotating to unlock. After the battery is replaced, the wrench 2 is brought close to the receiving cavity 3A. Under the guidance of the magnetic force, the wrench 2 automatically snaps into the correct position, achieving quick and effortless reinstallation.

In some embodiments, the lower surface 2A is provided with a receiving cavity 3A for accommodating at least a part of the wrench 2. The receiving cavity 3A is communicated with the battery avoiding port 11. A snap-fit member 18 is provided on the bottom wall 302 of the receiving cavity 3A, and a second slot 19 adapted to mate with the snap-fit member 18 is provided on the side of the wrench 2 facing the receiving cavity 3A. The wrench 2 is detachably mounted to the plate body 1 via the snap-fit member 18 and the second slot 19.

The snap-fit member 18 is provided on the bottom wall 302 of the receiving cavity 3A. The snap-fit member 18 is configured as an elastic snap-fit hook, a snap-fit block, or a snap-fit post protruding outward from the bottom wall. The snap-fit member 18 is integrally formed with the plate body 1, or the snap-fit member 18 is a separate member installed on the bottom wall by means such as embedding or fixation. The side of the wrench 2 facing the receiving cavity 3A is defined with the second slot 19, which corresponds in shape and position to the snap-fit member 18. The second slot 19 is configured as a recess, a hole, or a notch.

When the wrench 2 is installed within the receiving cavity 3A, the snap-fit member 18 engages into the second slot 19, forming a snap-fit connection that secures the wrench 2 to the plate body 1. The cooperation between the snap-fit member 18 and the second slot 19 provides a reliable mechanical locking force, preventing the wrench 2 from accidentally detaching during normal use caused by vibration or impact. When battery replacement is required, user operates the snap-fit member 18, causing it to elastically deform and disengage from the second slot 19, allowing the wrench 2 to be removed from the receiving cavity 3A. After the battery is replaced, the wrench 2 is aligned with the receiving cavity 3A and pressed into place. Under the restoring force of its elasticity, the snap-fit member 18 automatically snaps back into the second slot 19, completing the reinstallation of the wrench 2.

In some other embodiments, the magnetic attraction connection and the snap-fit connection are combined. For instance, both the first magnetic member 22 and the snap-fit member 18 are provided within the accommodation mechanism 3A; both the second magnetic member 15 and the second slot 19 are correspondingly provided on the wrench 2. In this configuration, the magnetic attraction provides guidance and initial alignment as the wrench 2 approaches the receiving cavity 3A, assisting its quick positioning. Meanwhile, the engagement between the snap-fit member 18 and the second slot 19 provides secure mechanical locking against detachment under substantial external force. This combination integrates the convenience of the magnetic connection with the reliability of the snap-fit connection, further enhancing the user experience.

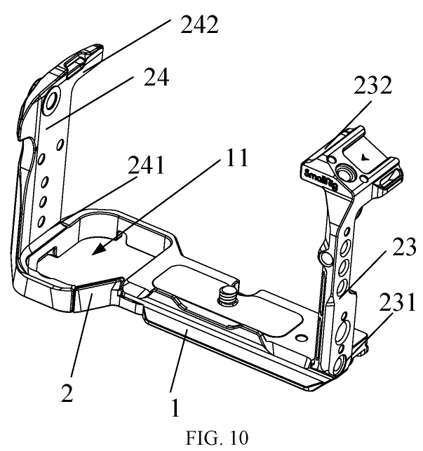

In some embodiments, referring to FIG. 10, the photographic expansion accessory includes a camera base plate 100 and a first frame 23. The camera base plate 100 includes a plate body 1 and a wrench 2. The plate body 1 is defined with a battery avoiding port 11 penetrating through the plate body 1. The wrench 2 is rotatably connected to the plate body 1 via a damping assembly 3, and the wrench 2 defines a part of the sidewall of the battery avoiding port 11. The first frame 23 includes an end 231 connected to an end of the plate body 1 and an extension end 232 extending in a direction away from the plate body 1.

In the embodiments, based on the foregoing embodiments in which the plate body 1 is provided with the damping assembly 3, the first frame 23 is provided on the plate body 1, forming a more comprehensive photographic expansion accessory that offers users greater possibilities for functional extension. The first frame 23 is connected to one end of the plate body 1 and extends in a direction away from the plate body 1. When the camera 200 is mounted on the plate body 1, the first frame 23 is positioned to one side of the camera 200, providing protection for the side surface of the camera 200. Various functional interfaces can be defined in the sidewall of the first frame 23. For example, a cold shoe interface is provided for mounting a photographic accessory such as an external flash, a microphone, a monitor, or a fill light. For another example, a snap-fit slot is provided for securing an accessory like a cable clamp or a smartphone holder. For yet another example, a threaded mounting hole is provided for connecting an expansion arm, such as a magic arm or an extension rod. Other functional interfaces like positioning holes or lashing holes can also be defined. By integrating these functional interfaces, the first frame 23 serves as an expansion platform for photographic accessories, meeting user needs for connecting various attachments in different shooting scenarios.

It should be noted that the connection between the first frame 23 and the plate body 1 can be implemented in various forms.

In an implementation, the first frame 23 and the plate body 1 are integrally formed, i.e., the first frame 23 and the plate body 1 are formed as a single piece from the same material through processes such as casting, forging, machining, or injection molding. This integral forming method ensures high connection strength and structural stability between the first frame 23 and the plate body 1, while also providing a clean overall appearance without assembly seams.

In another implementation, the first frame 23 is slidably connected to the plate body 1. For example, the plate body 1 is defined with an elongated hole extending along the length direction of the plate body 1. One end of the first frame 23 is provided with a connecting member, which is defined with a through hole corresponding to the elongated hole. A bolt or a screw passes through the through hole of the first frame 23 and the elongated hole of the plate body 1 to connect the first frame 23 to the plate body 1. Since the elongated hole has a certain length along the plate body 1, the first frame 23 is capable of sliding relative to the plate body 1 along the extension direction of the elongated hole when the bolt is not fully tightened. This allows for adjustment of the position of the first frame 23 relative to the plate body 1 to accommodate cameras 200 of different sizes or models. After the first frame 23 is adjusted to a desired position, the bolt is tightened and then the first frame 23 is secured in place. This slidably adjustable connection enhances the adaptability and versatility of the photographic expansion accessory to camera 200 of different models.

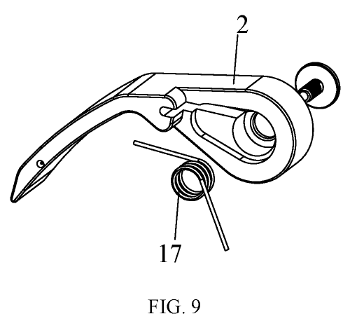

In some embodiments, with reference to FIG. 9, the photographic expansion accessory further includes a second frame 24. The second frame 24 includes an end 241 connected to the sidewall of the battery avoiding port 11 and an extension end 242 extending in a direction away from the plate body 1.

In the embodiments, in addition to the first frame 23, the second frame 24 is provided. The first frame 23, the second frame 24, and the plate body 1 collectively form a generally U-shaped frame structure for the photographic expansion accessory. One end of the second frame 24 is connected to the sidewall of the battery avoiding port 11, at a position on the plate body 1 opposite to the first frame 23. The extension end 242 of the second frame 24 extends away from the plate body 1 in a direction substantially parallel to the extension direction of the first frame 23. As a result, the first frame 23 and the second frame 24 are positioned on opposite sides of the camera 200, and the plate body 1 is located at the bottom of the camera 200. The first frame 23, the second frame 24, and the plate body 1 collectively form a U-shaped frame, providing wraparound protection for the bottom and both sides of the camera 200.

The connection between the second frame 24 and the plate body 1 can be implemented with reference to the aforementioned connection methods for the first frame 23 and the plate body 1, such as by integral forming or a slidably adjustable connection. In some embodiments, the sidewall of the second frame 24 is defined with a functional interface such as a cold shoe interface, a threaded mounting hole, a snap-fit slot, or a tie-down hole, which is configured to connect various photographic accessories, further enhancing the functional expandability of the photographic expansion accessory.

It should be noted that since one end of the second frame 24 is connected to the sidewall of the battery avoiding port 11, the arrangement of the second frame 24 does not obstruct or affect the functionality of the battery avoiding port 11. The wrench 2 can still be rotated or detached normally to open the gap of the battery avoiding port 11, allowing the cover to be received in it, facilitating battery replacement. In the embodiments, the second frame 24, the first frame 23, and the plate body 1 collectively form a U-shaped frame structure, which not only enhances the protective performance for the camera 200 but also provides more accessory mounting interfaces, making the functionality of the photographic expansion accessory more comprehensive.

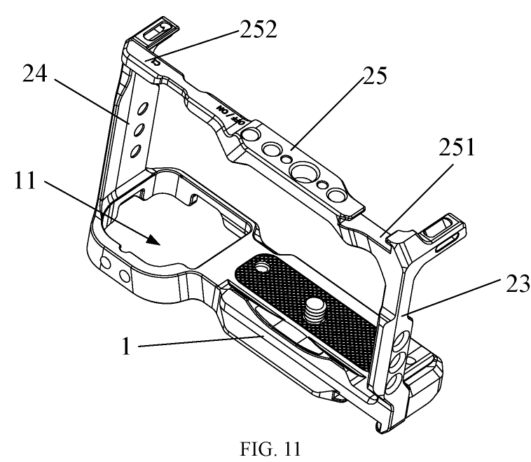

In some embodiments, with reference to FIG. 11, the photographic expansion accessory further includes a third frame 25. The third frame 25 includes an end 251 connected to the extension end 232 of the first frame 23 and an end 252 connected to the extension end 242 of the second frame 24.

In the embodiment, based on the providing of the first frame 23 and the second frame 24, the third frame 25 is additionally provided. The plate body 1, the first frame 23, the second frame 24, and the third frame 25 collectively enclose to form a rectangular frame structure for the photographic expansion accessory. The plate body 1 constitutes the bottom side of the rectangular frame, the first frame 23 and the second frame 24 constitute two opposite lateral sides of the rectangular frame, and the third frame 25 constitutes the top side of the rectangular frame, positioned opposite the plate body 1. In this configuration, the rectangular frame provides comprehensive surrounding protection for the bottom and all side surfaces of the camera 200, effectively safeguarding the camera 200 from accidental impacts, bumps, and other potential damage.

In some embodiments, the sidewall of the third frame 25 is defined with a functional interface such as a cold shoe interface, a threaded mounting hole, a snap-fit slot, and a tie-down hole, further enhancing the expansion capability of the photographic expansion accessory.

The connection between the third frame 25 and the first frame 23, and between the third frame 25 and the second frame 24 can be implemented based on actual requirements, which is not limited herein.

In an implementation, one end of the third frame 25 is integrally formed with or fixedly connected to the extending end of the first frame 23, and the other end of the third frame 25 is integrally formed with or fixedly connected to the extending end of the second frame 24, thereby forming a closed rectangular frame. In this configuration, the camera 200 can be placed into the frame from either above or below, and securely fastened by screws via threaded holes in the plate body 1. For example, the user can place the camera 200 into the interior of the frame along the opening direction of the rectangular frame, ensuring that the bottom of the camera 200 aligns with the plate body 1 and the surrounding side surfaces of the camera 200 are adjacent to the inner walls of the respective frames. Subsequently, screws are passed through the threaded holes in the plate body 1 and tightened into the threaded holes in the bottom of the camera 200, securely connecting the camera 200 to the photographic expansion accessory.

In another implementation, any one of the four frames is configured with an openable/closable connection. For example, one end of this frame is pivotally connected to an adjacent frame via a hinge or a rotating shaft, allowing it to rotate relative to the adjacent frame. The other end of this frame is detachably connected to another adjacent frame by a snap-fit mechanism. For example, when engaged, the snap-fit mechanism locks the frame in a closed position; when disengaged, the frame can be swung open outward. In this configuration, the user can first disengage the snap-fit mechanism to open the frame, place the camera 200 inside the enclosure and align it with the plate body 1, then swing the frame back to the closed position and engage the snap-fit mechanism to complete the installation of the camera 200. Compared to the method of sliding the camera 200 into a closed frame, this openable configuration provides greater convenience and speed for inserting and removing the camera 200.

In the embodiments, an additional third frame 25 is provided. The third frame 25, together with the plate body 1, the first frame 23, and the second frame 24, forms a complete rectangular frame structure. This provides all-around protection for the camera 200. Further, it offers additional accessory mounting interfaces and more flexible installation options for the camera 200, providing the photographic expansion accessory more functionality and broadening its range of application.

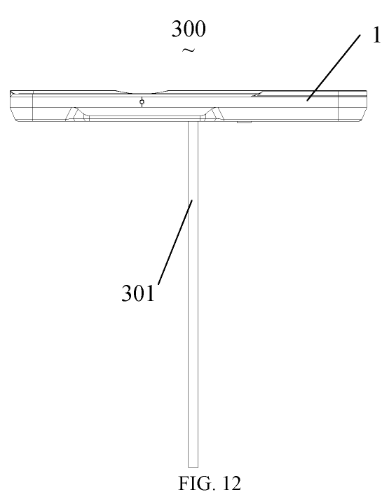

With reference to FIG. 12, the present disclosure further provides a photographic auxiliary apparatus 300, including a support stand 301 and a photographic expansion accessory mounted at an end of the support stand 301. The photographic expansion accessory is the one described in any one of the foregoing embodiments, and the structure of the photographic expansion accessory can refer to the foregoing embodiments. Since the photographic auxiliary apparatus 300 incorporates all the technical solutions of the foregoing embodiments, it consequently achieves at least all the technical effects brought about by those solutions, which is not detailed herein.

The support stand 301 is configured to support the photographic expansion accessory and a camera, such as the camera 200, mounted on the photographic expansion accessory, thereby providing a stable platform for photography. The support stand 301 can be any type of photographic support devices, such as, but not limited to, a tripod, a monopod, a gimbal head, a stabilizer, a photography arm, a desktop stand, or a handgrip, which is not limited herein.

The photographic expansion accessory is mounted to one end of the support stand 301. For example, the connection can be achieved via a quick-release interface, a threaded hole 14, or a standard tripod head interface provided on the lower surface 2A of the plate body 1. The photographic expansion accessory and the support stand 301 can be connected via threaded connection, quick-release buckle connection, or other conventional photographic equipment connection means.

By incorporating all the technical solutions of the foregoing embodiments, the photographic auxiliary apparatus 300 possesses all the corresponding technical effects. During use, when the battery of the camera 200 needs to be replaced, user is not required to detach the camera 200 from the photographic expansion accessory, nor to detach the photographic expansion accessory from the support stand 301. The user can simply operate the wrench 2 to open the gap at the battery avoiding port 11, thereby facilitating the battery removal and installation. This simplifies the operational procedure and enhances shooting efficiency. Other technical effects will not be detailed herein.

The above description is only a part or preferred embodiments of the present disclosure. Whether in words or in the drawings, it should not limit the scope of protection of the present disclosure. Any equivalent structural changes made by utilizing the contents of the present disclosure specification and drawings or directly/indirectly applying them in other relevant technical fields, under the overall concept of the present disclosure, are included in the scope of protection of the present disclosure.

What is claimed is:

1. A photographic expansion accessory, comprising a camera base plate, the camera base plate comprising a plate body and a wrench, the plate body being defined with a battery avoiding port, the battery avoiding port extending along a thickness direction of the plate body; the wrench being rotatably connected to the plate body, and the wrench defining a part of a sidewall of the battery avoiding port.

2. The photographic expansion accessory of claim 1, further comprising:
a damping assembly disposed between the plate body and the wrench;
wherein the wrench is rotatably connected to the plate body via the damping assembly.

3. The photographic expansion accessory of claim 2, wherein the damping assembly comprises:
a shaft, the shaft comprising an end connected to the plate body and the other end rotatably connected to the wrench.

4. The photographic expansion accessory of claim 3, wherein the damping assembly further comprises at least one first washer; wherein,
the at least one first washer is disposed between the wrench and the plate body; and/or,
the at least one first washer is disposed on a side of the wrench facing away from the plate body.

5. The photographic expansion accessory of claim 2, wherein the damping assembly comprises a shaft, a first connecting member, a second connecting member, and at least one first washer; the first connecting member, the second connecting member, and the first washer are all located between two ends of the shaft; the first connecting member is rotatably sleeved on the shaft, the second connecting member and the first washer are sleeved on the shaft, the at least one first washer is located between the first connecting member and the second connecting member, the first connecting member is fixedly connected to the wrench, and the second connecting member is fixedly connected to the plate body.

6. The photographic expansion accessory of claim 2, wherein the damping assembly comprises a second connecting member, a shaft, and at least one first washer; wherein,
the second connecting member is mounted to the plate body;
the shaft comprises an end connected to the second connecting member and the other end rotatably connected to the wrench; and
the at least one first washer is fitted on the shaft and located between the wrench and the second connecting member.

7. The photographic expansion accessory of claim 5, wherein the damping assembly further comprises at least one elastic member sleeved on the shaft, and the elastic member is located on a side of the first connecting member away from the second connecting member, or on a side of the second connecting member away from the first connecting member.

8. The photographic expansion accessory of claim 7, wherein the damping assembly further comprises a second washer, the second washer comprises a first surface abutted the elastic member and a second surface abutted a side of the first connecting member; the second surface is provided with at least one limiting protrusion and the first connecting member is correspondingly defined with at least one slot, or, the second surface is defined with at least one slot and the first connecting member is correspondingly provided with at least one limiting protrusion, and each limiting protrusion is capable of sliding into or out of a respective slot; or,
the second surface of the second washer abuts a side of the second connecting member; the second surface is provided with at least one limiting protrusion and the second connecting member is correspondingly defined with at least one slot, or, the second surface is defined with at least one slot and the second connecting member is correspondingly provided with at least one limiting protrusion.

9. The photographic expansion accessory of claim 8, wherein at least one side of the limiting protrusion is provided with a first guiding slope, at least one inner side wall of the first slot is correspondingly provided with a second guiding slope, and the first guiding slope abuts the second guiding slope.

10. The photographic expansion accessory of claim 9, wherein the limiting protrusion comprises two opposite sides with each being provided with the first guiding slope, when the limiting protrusion is arranged on the second surface, a distance between the two first guiding slopes gradually decreases in a direction away from the second surface; when the limiting protrusion is arranged on the first connecting member or the second connecting member, the distance between the two first guiding slopes gradually increases in the direction away from the second surface; the slot comprises two opposite sides with each being provided with the second guiding slopes, and a distance between the two second guiding slopes gradually increases in a direction away from a bottom wall of the slot.

11. The photographic expansion accessory of claim 1, wherein the plate body comprises an upper surface and a lower surface opposite to the upper surface in the thickness direction of the plate body, the upper surface is configured to support a camera, and the lower surface is configured to connect to a support stand;
the lower surface is defined with a receiving cavity configured to receive at least a part of the wrench, the receiving cavity is communicated with the battery avoiding port;
a rotating shaft is provided on a bottom wall of the receiving cavity, and the rotating shaft extends in a direction away from the upper surface; and
a torsion spring and the wrench are sequentially fitted on the rotating shaft, the wrench is rotatably arranged within the receiving cavity through the rotating shaft, and the torsion spring is configured to reset the wrench to a preset position.

12. A photographic expansion accessory, comprising a plate body and a wrench, wherein the plate body comprises an upper surface and a lower surface opposite to the upper surface, the upper surface is configured to support a camera, and the lower surface is configured to connect to a support stand;
the plate body is defined with a battery avoiding port penetrating through the upper surface and the lower surface, and the battery avoiding port is arranged to correspond to an opening of a battery compartment of the camera; and
the wrench is detachably connected to the plate body, and the wrench defines a part of a sidewall of the battery avoiding port.

13. The photographic expansion accessory of claim 12, wherein the lower surface of the plate body is defined with a receiving cavity for receiving at least a part of the wrench, and the receiving cavity is communicated with the battery avoiding port; and
a first magnetic member is provided on an inner wall of the receiving cavity, a second magnetic member is provided on the wrench, and the wrench is detachably mounted to the plate body through the first magnetic member and the second magnetic member.

14. The photographic expansion accessory of claim 12, wherein the lower surface of the plate body is defined with a receiving cavity for receiving at least a part of the wrench, and the receiving cavity is communicated with the battery avoiding port; and
a snap-fit member is provided on a bottom wall of the receiving cavity, a second slot mating with the snap-fit member is defined in a surface of the wrench facing the receiving cavity, and the wrench is detachably mounted to the plate body by way of the snap-fit member clamping in the second slot.

15. A photographic expansion accessory, comprising:
a camera base plate, the camera base plate comprising a plate body and a wrench, the plate body being defined with a battery avoiding port penetrating through the plate body, the wrench being rotatably connected to the plate body through a damping assembly, and the wrench defining a part of a sidewall of the battery avoiding port; and
a first frame, the first frame comprising an end connected to an end of the plate body and an extension end extending away from the plate body.

16. The photographic expansion accessory of claim 15, further comprising:
a second frame, the second frame comprising an end connected to the sidewall of the battery avoiding port and an extension end extending away from the plate body.

17. The photographic expansion accessory of claim 16, further comprising:
a third frame, the third frame comprising an end connected to the extension end of the first frame and the other end connected to the extension end of the second frame.

18. A photographic auxiliary apparatus, comprising a support stand and a photographic expansion accessory mounted at an end of the support stand, wherein the photographic expansion accessory is the photographic expansion accessory of claim 1.

19. A photographic auxiliary apparatus, comprising a support stand and a photographic expansion accessory mounted at an end of the support stand, wherein the photographic expansion accessory is the photographic expansion accessory of claim 12.

20. A photographic auxiliary apparatus, comprising a support stand and a photographic expansion accessory mounted at an end of the support stand, wherein the photographic expansion accessory is the photographic expansion accessory of claim 15.
